(19) United States
(12) Patent Application Publication
(10) Pub. No.: US 2026/0308946 A1
(43) Pub. Date: Oct. 8, 2026

(54) VEHICLE STRIKER MOUNTED LATCH PRELOAD DEVICE

(71) Applicant: Ford Global Technologies, LLC, Dearborn, MI (US)

(72) Inventor: Daniel Trentin, Ivanhoe (AU)

(73) Assignee: Ford Global Technologies, LLC, Dearborn, MI (US)

(21) Appl. No.: 19/172,831

(22) Filed: Apr. 8, 2025

(51) Int. Cl. E05B 77/38; E05B 85/04; E05B 77/36

(52) U.S. Cl. CPC E05B 77/38; E05B 85/045; E05B 77/36

(57) ABSTRACT

A latch preload device for mounting on a striker on a vehicle has a collar configured to engage the striker. First and second opposing cantilevered leaf springs are supported by the collar. The first and second cantilevered leaf springs are configured to engage contact surfaces on a base plate of a latch assembly in a latched position, such that the base plate compresses the first and second cantilevered leaf springs to apply a load force. First and second opposing gripper arms extend from terminal ends of the first and second opposing cantilevered leaf springs and are configured to engage and grip the striker.

### FIELD OF THE DISCLOSURE

The present disclosure generally relates to vehicle latch assemblies, and more particularly relates to a force loaded striker and latch assembly that reduces or prevents rattle of a body such as a closure body on a motor vehicle.

### BACKGROUND OF THE DISCLOSURE

Motor vehicles are commonly equipped with latches such as door closure latches. For example, passenger vehicles typically have a plurality of passenger doors, each of which moves between an open door position and a closed door position and commonly includes a striker and latch assembly for latching the door in the closed door position. To insure a snug fit and reduce movement and chucking, the latch assembly may include a rubber bump stop. It would be desirable to provide for a preload device that provides a preload force to reduce door rattle with enhanced performance.

### SUMMARY OF THE DISCLOSURE

According to a first aspect of the present disclosure, a latch preload device for mounting on a striker on a vehicle has a collar configured to engage the striker. First and second opposing cantilevered leaf springs are supported by the collar. The first and second cantilevered leaf springs are configured to engage contact surfaces on a base plate of a latch assembly in a latched position, such that the base plate compresses the first and second cantilevered leaf springs to apply a load force. First and second opposing gripper arms extend from terminal ends of the first and second opposing cantilevered leaf springs and are configured to engage and grip the striker.

Embodiments of the first aspect of the present disclosure can include any one or a combination of the following features:

the first and second cantilevered leaf springs are connected via a C-shaped portion;

the striker has a U-shaped striker bar having first and second bars;

the first and second grippers have terminal ends that are spaced from each other and configured to engage the first bar of the U-shaped striker bar;

the collar has a substantially rectangular shape with rounded corners;

the latch preload device may be installed and removed from the U-shaped striker;

the latch preload device is configured to be installed on the striker on the vehicle and configured to engage the latch assembly on a vehicle closure;

the latch preload device comprises metal; and

the metal comprises spring steel.

According to a second aspect of the present disclosure, a vehicle striker for latching with a latch assembly on a vehicle has a base plate configured to connect to one of a fixed body on a vehicle and a moveable body on the vehicle, a U-shaped striker extending from the base plate, and a latch preload device. The latch preload device has a collar configured to engage a U-shaped striker bar. First and second opposing cantilevered leaf springs are supported by the collar. The first and second cantilevered leaf springs are configured to engage contact surfaces on a base plate of a latch assembly in a latched position, such that the base plate compresses the first and second cantilevered leaf springs to apply a load force. First and second opposing gripper arms extend from terminal ends of the first and second opposing cantilevered leaf springs and are configured to engage and grip the U-shaped striker bar on a side.

Embodiments of the second aspect of the present disclosure can include any one or a combination of the following features:

the first and second cantilevered leaf springs are connected via a C-shaped portion;

the first and second grippers have terminal ends that are spaced from each other and configured to engage one bar portion of the U-shaped striker bar;

the collar has a substantially rectangular shape with rounded corners;

the latch preload device may be installed and removed from the U-shaped striker;

the latch preload device is configured to be installed on a striker located on a vehicle and configured to engage a latch assembly on a vehicle closure;

the latch preload device comprises metal; and

the metal comprises spring steel.

According to a third aspect of the present disclosure, a vehicle has a closure door, a door well, a latch assembly located on the closure door, a U-shaped striker located on the door well and a latch preload device for mounting on a striker on a vehicle. The latch preload device has a collar configured to engage the striker. First and second opposing cantilevered leaf springs are supported by the collar. The first and second cantilevered leaf springs are configured to engage contact surfaces on a base plate of a latch assembly in a latched position, such that the base plate compresses the first and second cantilevered leaf springs to apply a load force. First and second opposing gripper arms extend from terminal ends of the first and second opposing cantilevered leaf springs and are configured to engage and grip the striker.

Embodiments of the third aspect of the present disclosure can include any one or a combination of the following features:

the striker has a U-shaped striker bar having first and second bars; and

the first and second grippers have terminal ends that are spaced from each other and configured to engage the first bar of the U-shaped striker bar.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a motor vehicle configured having passenger doors each equipped with a latch assembly and striker, according to one embodiment;

FIG. 2 is a side perspective view of the motor vehicle of FIG. 1 with a passenger door in the open position;

FIG. 3 is a side perspective view of the latch assembly and striker shown in an unlatched position;

FIG. 3A is a side view of the latch assembly and striker in the unlatched position as shown in FIG. 3;

FIG. 4 is a side perspective view of the latch assembly and striker shown in a latched position with a latch preload device loaded;

FIG. 4A is a side view of the latch assembly and striker as shown in the latched position in FIG. 4;

FIG. 5 is an upper right side perspective view of the striker having the preload device assembled thereon;

FIG. 6 is an upper left side perspective view of the striker with the preload device as shown in FIG. 5; and

FIG. 7 is an exploded upper perspective view of the preload device exploded from the striker.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

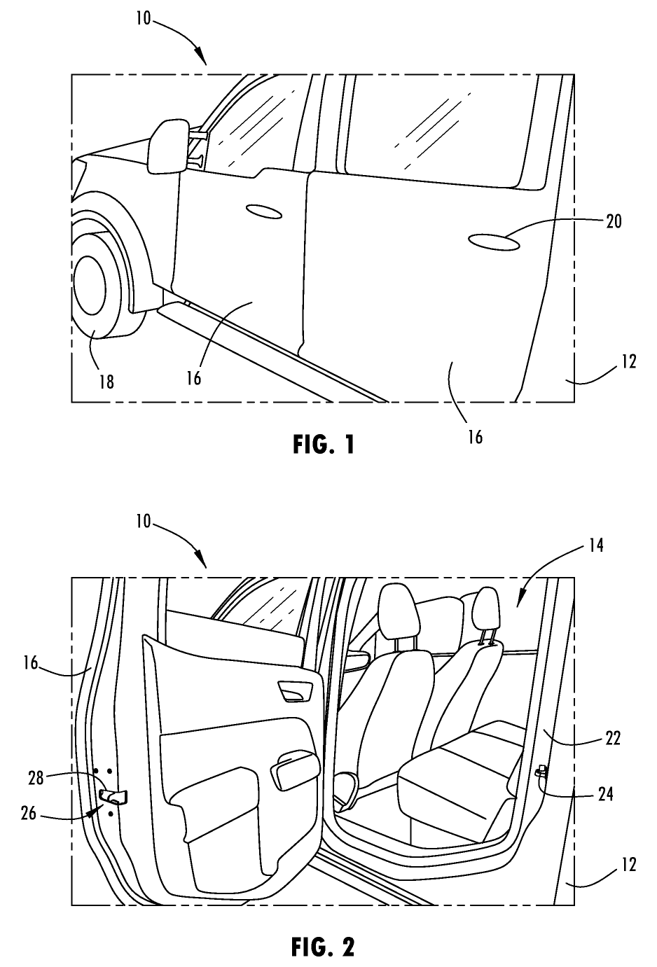

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a latch preload device for mounting on a vehicle striker. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

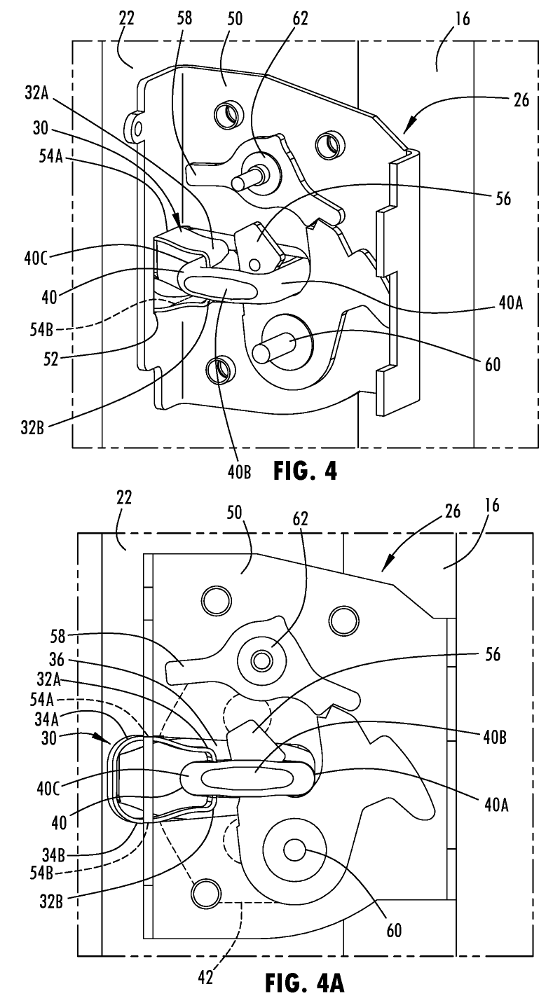

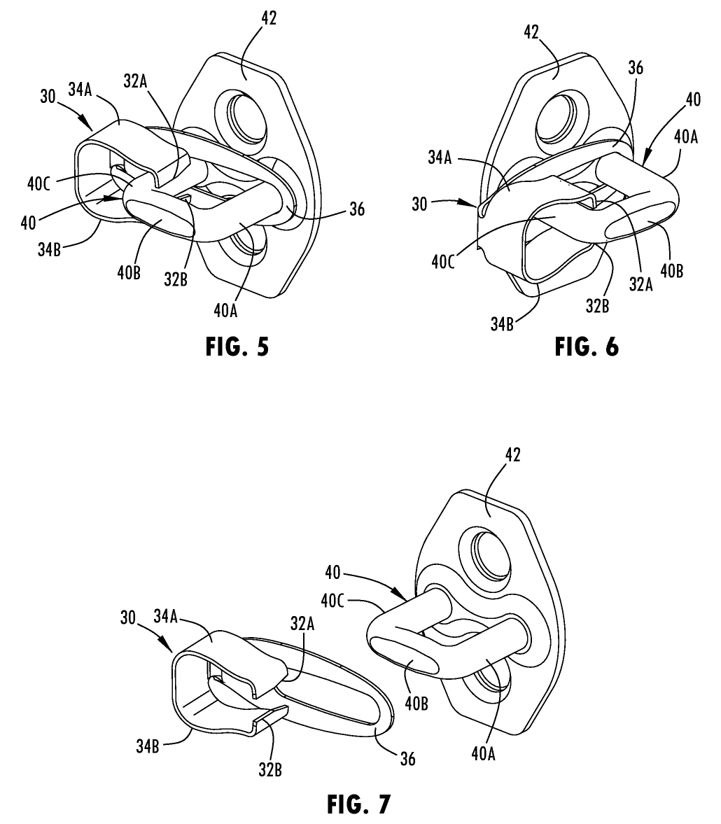

Referring to FIGS. 1-7, a motor vehicle 10 is generally shown having a latch preload device 30 configured for mounting on a striker 40 on the motor vehicle 10. The latch preload device 30 has a collar 36 configured to engage the striker 40 and first and second opposing cantilevered leaf springs 34A and 34B supported on the collar 36, wherein the first and second cantilevered leaf springs 34A and 34B are configured to engage contact surfaces on a base plate 42 of a latch assembly 26 in a latched position such that the base plate 42 compresses the first and second cantilevered leaf springs 34A and 34B to apply a load force. First and second gripper arms 32A and 32B extend from terminal ends of the first and second opposing cantilevered leaf springs 34A and 34B and are configured to engage and grip the striker 40.

The motor vehicle 10, shown in one example in FIGS. 1 and 2, is a wheeled automotive vehicle that has a vehicle body 12 that defines a cabin interior 14 that is generally configured as a passenger cabin. The cabin interior 14 typically includes a configuration of vehicle seating assemblies for seating vehicle occupants and various vehicle controls and accessories. The vehicle body 12 includes closure bodies shown as closure doors 16 including passenger access doors which allow access to the cabin interior 14. The closure doors pivot about one end between closed and open positions, and each closure door has a door handle 20 operatively coupled to a latch assembly 26. The motor vehicle 10 may be a wheeled motor vehicle that is equipped with a plurality of tire and wheel assemblies 64, for example.

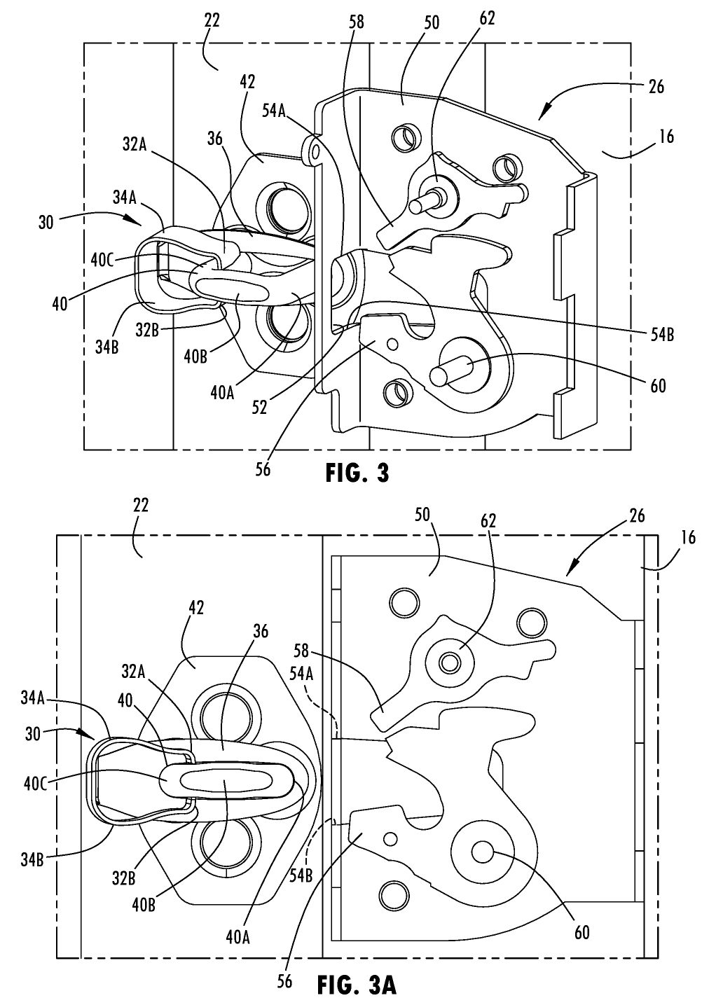

The latch assembly 26 is illustrated in detail in FIGS. 3-7. The latch assembly 26 includes the latch body 50 which is connected to the closure door 16 on one end of the door 16 such as via fasteners, rivets, welding or other connectors. The latch assembly 26 is located on the end of the door opposite a hinged connection. The latch body 50 generally has the latch components assembled thereon and supports the latch assembly 26 in a position aligned to matingly engage a striker 40 which extends from a door frame 22 such as on or near the door jamb. The striker 40 is shown in one configuration as a U-shaped striker having a pair of outward extending rod portions extending outward from a base plate 42 and connected together by an outer rod portion. It should be appreciated that the striker 40 may take the form of other shapes such as a pair of parallel rods or a C-shape and may be configured in other sizes.

The striker 40 is shown having a latch preload device 30 assembled onto the striker 40. The latch preload device 30 is configured to provide a preload force against the latch assembly 26 when the latch assembly 26 matingly engages the striker 40 and latch preload device 30 with force into the latched position. The latch preload device 30 may be installed with force onto the striker 40 and may slide along a tapered surface and snap into place and be fixedly held by the tapered surface and may further include a recess or detents or otherwise be connected to the striker 40.

The latch preload device 30 has an elongated shaped collar 36 that forms and encircles the pair of parallel outward extending striker bar portions of the striker 40 proximate the base plate 42 of the striker 40. The collar 36 may be inserted over and onto the striker 40 and forced towards the base plate 42 to slide along the tapered surface until the latch preload device 30 snaps into place along the tapered surface or within a recess proximate the base plate 42. As such, the latch preload device 30 may be original installed equipment or may be installed as an aftermarket or replaceable component.

The latch preload device 30 includes a first cantilevered leaf spring 34A and a second cantilevered leaf spring 34B interconnected with a C-shaped portion. The terminal ends of the first and second cantilevered leaf springs 34A and 34B have a pair of opposing gripper arms 32A and 32B. The latch preload device 30 may be made of metal, such as spring steel, for example. It should be appreciated that the latch preload device 30 may be made of other spring like materials such as a polymer material according to other examples. The gripper arms 32A and 32B form the terminal ends of the first and second cantilevered leaf springs 34A and 34B and are configured to engage the striker bar 40 under tension such that the cantilevered leaf springs 34A and 34B are generally force loaded. With the latch preload device 30 installed on the striker 40, the latch assembly 26 may be brought into contact with the striker 40. In doing so, contact walls 54A and 54B serving as contact surfaces on upper and lower edges defining an aperture 52 in the latch body 50 passes over the striker 40 and into engagement with the first and second cantilevered leaf springs 34A and 34B. As such, the forced contact of the contact walls 54A and 54B onto the first and second cantilevered leaf springs 34A and 34B provides a force preload which stabilizes the positioning of the latch body 50 onto the striker 40 so as to prevent rattle or other movement of the striker 40 and latch assembly 26 components relating to each other.

The latch assembly 26 includes a jaw 56 on a lower portion and a pawl 58 on an upper portion, wherein the jaw 56 and pawl 58 are mounted on the latch body 50 and configured to engage and hold onto the striker 40 in the latched position. The jaw 56 includes a first latch spring 60 for biasing the jaw 56 towards the unlatched position. Similarly, the pawl 58 includes a second latch spring 62 biasing the pawl 58 to a locked pawl 58 position engaging a tooth on a lock. When the door 16 moves from the open position to the closed position to latch closed, the striker 40 passes through aperture 52 in the latch body 50 and the jaw 56 allows the striker 40 to pass over and engage within and be held by the jaw 56 and pawl 58 to maintain the striker 40 within the latch assembly 26 in the latched position. When a user pulls on the door handle 20 on the exterior of the door 16, the pawl 58 is actuated to move to an open position to release engagement of the jaw 56 with the striker 40 and allow the door 16 to move from the closed position to the open position. It should be appreciated that the latch assembly 26 may be configured with alternative latching components that are different from the jaw 56 and pawl 58 arrangement shown according to other embodiments.

The latch assembly 26 may be assembled onto one of a moveable part on the motor vehicle 10 and a fixed part on the motor vehicle 10 for engaging a striker 40 located on the other of the moveable part of the motor vehicle 10 and the fixed part of the motor vehicle 10. In the example shown and described herein, the latch assembly 26 is provided on the moveable part shown configured as the door 16 of the motor vehicle 10, and the striker 40 is shown provided on the fixed part which may include the door well 22 of the motor vehicle 10. It should be appreciated that the latch assembly 26 may otherwise be provided on the fixed part of the motor vehicle 10 to engage the striker 40 provided on the moveable part of the motor vehicle 10, according to other embodiments.

While the latch assembly 26 is shown and described herein for use in latching a door 16 of a motor vehicle 10 onto a fixed support structure on or proximate the body 12 of the motor vehicle 10, it should be appreciated that the latch assembly 26 may be otherwise configured to latch other moveable parts to a fixed part on the motor vehicle 10. For example, the latch assembly 26 may be used for other closures, such as for latching a liftgate on a sport utility vehicle (SUV) in the closed position at the rear of the motor vehicle 10, or latching a tailgate of the motor vehicle 10 in a closed position, or latching a hood of the motor vehicle 10 or a trunk of the motor vehicle 10 in a closed position. It should further be appreciated that the latch assembly 26 may be useful for a motor vehicle 10 for latching a seat assembly, such as latching a seat back to a seat base and allowing the seat back to flip to a stowed position, and further for latching the seat base to an underlying support structure on the cabin floor to allow the seat to flip to a stowed position, such as a forward vertical position.

Accordingly, a latch assembly 26 for a motor vehicle 10 is provided that advantageously provides for a latch preload device 30 for applying a loaded force onto a latch body 50 on a latch assembly 26 so as to reduce or prevent movement of a moveable part such as the door 16 and latch assembly 26 relative to the fixed vehicle structure such as the body 50 and striker 40 which may otherwise result in unwanted movement of the components and associated rattle noise. This may advantageously reduce the need for rubber bump stops and may offer a tighter working range of tolerances.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A latch preload device for mounting on a striker on a vehicle, the latch preload device comprising:
a collar configured to engage the striker;
first and second opposing cantilevered leaf springs supported by the collar, wherein the first and second cantilevered leaf springs are configured to engage contact surfaces on a base plate of a latch assembly in a latched position, such that the base plate compresses the first and second cantilevered leaf springs to apply a load force; and
first and second opposing gripper arms extending from terminal ends of the first and second opposing cantilevered leaf springs and configured to engage and grip the striker.

2. The latch preload device of claim 1, wherein the first and second cantilevered leaf springs are connected via a C-shaped portion.

3. The latch preload device of claim 1, wherein the striker has a U-shaped striker bar having first and second bars.

4. The latch preload device of claim 3, wherein the first and second grippers have terminal ends that are spaced from each other and configured to engage the first bar of the U-shaped striker bar.

5. The latch preload device of claim 4, wherein the collar has a substantially rectangular shape with rounded corners.

6. The latch preload device of claim 5, wherein the latch preload device may be installed and removed from the U-shaped striker.

7. The latch preload device of claim 1, wherein the latch preload device is configured to be installed on the striker on the vehicle and configured to engage the latch assembly on a vehicle closure.

8. The latch preload device of claim 1, wherein the latch preload device comprises metal.

9. The latch preload device of claim 8, wherein the metal comprises spring steel.

10. A vehicle striker for latching with a latch assembly on a vehicle, the vehicle striker comprising:
a base plate configured to connect to one of a fixed body on a vehicle and a moveable body on the vehicle;
a U-shaped striker extending from the base plate; and
a latch preload device comprising:
a collar configured to engage a U-shaped striker bar;
first and second opposing cantilevered leaf springs supported by the collar, wherein the first and second cantilevered leaf springs are configured to engage contact surfaces on a base plate of a latch assembly in a latched position, such that the base plate compresses the first and second cantilevered leaf springs to apply a load force; and
first and second opposing gripper arms extending from terminal ends of the first and second opposing cantilevered leaf springs and configured to engage and grip the U-shaped striker bar on a side.

11. The vehicle striker of claim 10, wherein the first and second cantilevered leaf springs are connected via a C-shaped portion.

12. The vehicle striker of claim 10, wherein the first and second grippers have terminal ends that are spaced from each other and configured to engage one bar portion of the U-shaped striker bar.

13. The vehicle striker of claim 10, wherein the collar has a substantially rectangular shape with rounded corners.

14. The vehicle striker of claim 10, wherein the latch preload device may be installed and removed from the U-shaped striker.

15. The vehicle striker of claim 10, wherein the latch preload device is configured to be installed on a striker located on a vehicle and configured to engage a latch assembly on a vehicle closure.

16. The vehicle striker of claim 10, wherein the latch preload device comprises metal.

17. The vehicle striker of claim 16, wherein the metal comprises spring steel.

18. A vehicle comprising:
a closure door;
a door well;
a latch assembly located on the closure door;
a U-shaped striker located on the door well; and
a latch preload device for mounting on a striker on a vehicle, the latch preload device comprising:
a collar configured to engage the striker;
first and second opposing cantilevered leaf springs supported by the collar, wherein the first and second cantilevered leaf springs are configured to engage contact surfaces on a base plate of a latch assembly in a latched position, such that the base plate compresses the first and second cantilevered leaf springs to apply a load force; and
first and second opposing gripper arms extending from terminal ends of the first and second opposing cantilevered leaf springs and configured to engage and grip the striker, wherein the first and second cantilevered leaf springs are connected via a C-shaped portion.

19. The vehicle of claim 18, wherein the striker has a U-shaped striker bar having first and second bars.

20. The vehicle of claim 19, wherein the first and second grippers have terminal ends that are spaced from each other and configured to engage the first bar of the U-shaped striker bar.
